(19) United States
(12) Patent Application Publication
(10) Pub. No.: US 2025/0199491 A1
(43) Pub. Date: Jun. 19, 2025

(54) SERVICE SETTING DEVICE, HOME CONTROL SYSTEM AND SERVICE MANAGEMENT METHOD

(71) Applicant: Mitsubishi Electric Corporation, Tokyo (JP)

(72) Inventors: Kentaro SAWA, Tokyo (JP); Satoshi HANAI, Tokyo (JP); Takamitsu YAMADA, Tokyo (JP)

(21) Appl. No.: 18/851,773

(22) PCT Filed: Apr. 13, 2022
(86) PCT No.: PCT/JP2022/017743

§ 371 Date: Sep. 27, 2024

(51) Int. Cl. G05B 15/02

(52) U.S. Cl. CPC G05B 15/02

(57) ABSTRACT

The network searcher collects functional information indicating functions of devices connected to a home network. The service manager identifies, based on the functional information collected by the network searcher and a service list associating services and functions necessary for the services, an available service that is available by combining the functions of the devices. A display displays the available service identified by the service manager.

### TECHNICAL FIELD

The present disclosure relates to a service setting device, a home control system, a service management method, and a program.

### BACKGROUND ART

Home control systems are known that utilize Internet of Things (IoT) technology to control multiple devices arranged in a home in cooperation with each other and to thereby improve comfort and convenience of a living environment. In such home control systems, communication specifications such as frame formats and connection sequences are standardized to allow devices to communicate with each other. In such home control systems, however, no definition is provided on how to achieve a service using the functions of the multiple devices.

A technique relating to such home control systems is disclosed in, for example, Patent Literature 1. In the home control system of Patent Literature 1, control of devices are performed based on information obtained from the devices that are connected to a home network. In particular, the home control system of Patent Document 1 includes a home gateway device through which devices arranged in the home are remotely controlled, and this home gateway device periodically detects devices on the network and manages the latest device information.

### CITATION LIST

### Patent Literature

Patent Literature 1: Unexamined Japanese Patent Application Publication No. 2007-53530

### SUMMARY OF INVENTION

### Technical Problem

Although the aforementioned home control system enables providing a service that combines the functions of the multiple devices, in reality, it is necessary that a professional worker understands the devices connected to the home network and the functions of these devices, and then performs, based on the understanding, a setting for communication between the devices, a setting relating to data to be collected, and a setting of a necessary control logic on the devices. That is, a user is in a situation of being uncertain about the types of services that are available by combining the functions of the devices connected to the user's home network, unless the user ask a worker to do a work.

Additionally, even after the user asks a worker to do the work and the service that combines the functions of the multiple devices becomes available, addition of a new device to the home network or replacement of an existing device with a new device may usually occur. Such cases are extremely troublesome to the users, since asking a worker to do an additional work is required.

For the aforementioned reasons, a technique is demanded for presenting to the user a service that is available by combining functions of devices connected to a home network and providing this service simply with an instruction from the user to enable the service.

The present disclosure is made to solve the aforementioned problems, and an objective of the present disclosure is to provide a service setting device, a home control system, a service management method, and a program that enable presenting an available service to a user.

### Solution to Problem

To achieve the above objective, a service setting device according to the present disclosure includes collection means for collecting functional information indicating functions of devices connected to a home network, identification means for identifying, based on the functional information collected by the collection means and a list associating services and functions necessary for the services, an available service that is available by combining the functions of the devices, and display means for displaying the available service identified by the identification means.

### Advantageous Effects of Invention

According to the service setting device according to the present disclosure, the collection means collects the functional information of the devices connected to the home network, the identification means identifies, based on the functional information and the list, the available service that is available by combining the functions of the devices, and the display means displays the available service identified by the identification means. As a result, available services can be presented to the user.

### BRIEF DESCRIPTION OF DRAWINGS

FIG. 1 is a schematic diagram illustrating an example of overall configuration of a home control system according to Embodiment 1 of the present disclosure;

FIG. 2 is a block diagram illustrating an example of configuration of a service setting device according to Embodiment 1 of the present disclosure;

FIG. 3 is a schematic diagram illustrating an example service list;

FIG. 4 is a schematic diagram illustrating an example of functional information according to Embodiment 1 of the present disclosure;

FIG. 5 is a schematic diagram for explanation of a mode of generating an available service list according to Embodiment 1 of the present disclosure;

FIG. 6 is a schematic diagram for explanation of a mode of generating an unavailable service list according to Embodiment 1 of the present disclosure;

FIG. 7 is a schematic diagram for explanation of a mode of performing settings on target devices;

FIG. 8 illustrates an example of a notification screen;

FIG. 9 is a flowchart for explanation of an example of collection processing;

FIG. 10 is a flowchart for explanation of an example of list generation processing;

FIG. 11 is a flowchart for explanation of an example of setting processing;

FIG. 12 is a block diagram illustrating an example of configuration of a service setting device according to Embodiment 2 of the present disclosure;

FIG. 13 is a schematic diagram illustrating an example of functional information according to Embodiment 2 of the present disclosure;

FIG. 14 illustrates an example of a selection screen;

FIG. 15 is a schematic diagram for explanation of a mode of generating an available service list according to Embodiment 2 of the present disclosure;

FIG. 16 is a schematic diagram for explanation of a mode of generating an unavailable service list according to Embodiment 2 of the present disclosure; and

FIG. 17 is a flowchart for explanation of an example of modification processing.

### DESCRIPTION OF EMBODIMENTS

Hereinafter, embodiments of the present disclosure are described in detail with reference to the drawings. In the drawings, components that are the same or equivalent are assigned the same reference sign. Although a home control system for controlling a device within a home is described below as an example, the present disclosure can also be used for a home control system for controlling a device within a facility such as an office building and a factory, as described below. That is, embodiments for explanation are described below, and the below description does not limit the scope of the present disclosure. Thus, persons of the ordinary skill in the art can adopt an embodiment obtained by replacing some or all of the elements with equivalents to the elements, and such an embodiment is also included in the scope of the present disclosure.

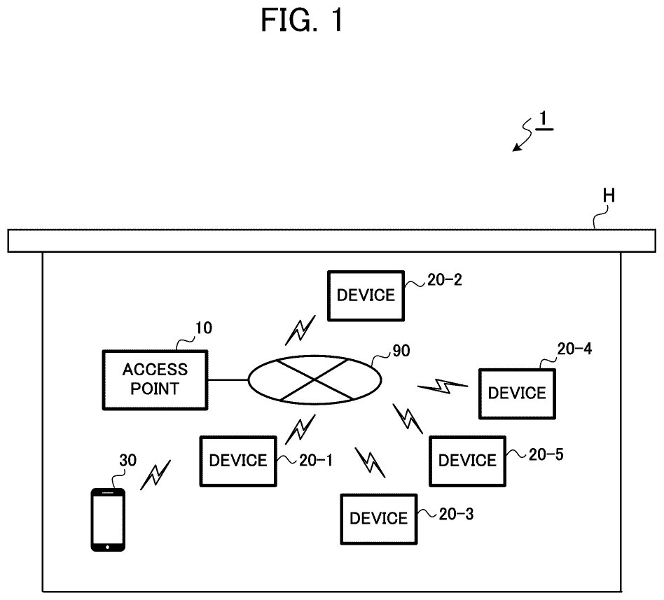

Embodiment 1 FIG. 1 is a schematic diagram illustrating an example of overall configuration of a home control system 1 according to Embodiment 1 of the present disclosure. This home control system 1 is, for example, a system that controls various devices arranged in a house H, and includes an access point 10, multiple devices 20 that are devices 20-1 through 20-5, and a service setting device 30. The access point 10, the multiple devices 20, and the service setting device 30 are communicably connected via a home network 90. The home network 90 is a network that is, for example, a wired local area network (LAN) or a wireless LAN.

The access point 10 is, for example, a wired or wireless communication device and builds the home network 90 that allows the devices 20 to communicate with one another.

The devices 20 that are the devices 20-1 through 20-5 are various devices installed in the house H and are capable of communicating via the home network 90. For example, the devices 20 communicate with one another through the application layer in the home network 90. The communication protocol may use “Matter” that is a standard for smart home.

Hereinafter, an example case is described where, of the devices 20, the device 20-1 is a controller, the device 20-2 is an air conditioner, the device 20-3 is a blower, the device 20-4 is a temperature sensor, and device 20-5 is a humidity sensor. The controller that is the device 20-1 is, for example, a home energy management system (HEMS) controller.

The service setting device 30 is, for example, a smartphone or laptop computer used by the user, and presents to the user services that can be achieved by combining the functions of the devices 20. In addition, to enable actual provision of a presented service, the service setting device 30 performs necessary settings on target devices 20. The service setting device 30 is not limited to a smartphone, laptop computer, and the like, and may be other device including a user interface, such as a television, smart speaker, or gateway.

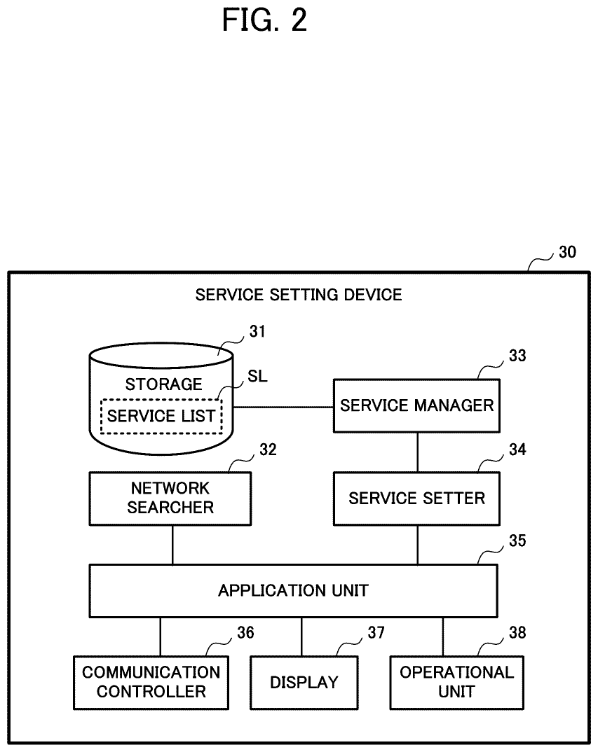

Next, the service setting device 30 is described in detail with reference to FIG. 2. FIG. 2 is a block diagram illustrating an example of configuration of the service setting device 30 according to Embodiment 1 of the present disclosure.

As illustrated in FIG. 2, the service setting device 30 includes a storage 31, a network searcher 32 that is an example of collection means, a service manager 33 that is an example of identification means, a service setter 34 that is an example of setting means, an application unit 35, a communication controller 36, a display 37 that is an example of display means, and an operational unit 38. The network searcher 32, the service manager 33, the service setter 34, and the application unit 35 are achieved by, for example, a central processing unit (CPU) using a random-access memory (RAM) as a work memory to appropriately execute a program stored in a read-only memory (ROM).

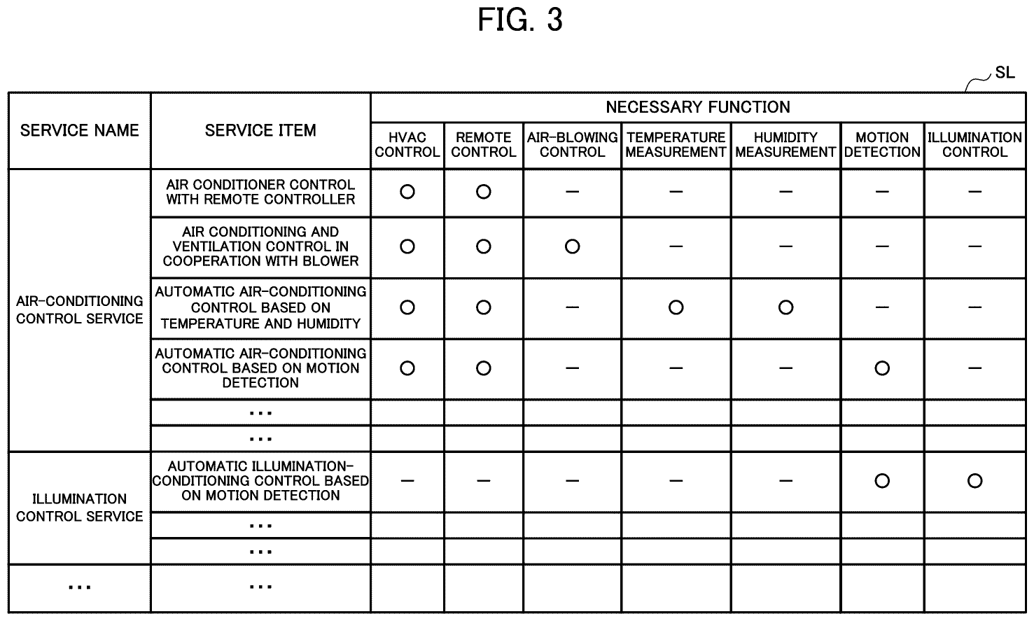

The storage 31 is a solid state drive (SSD), hard disk, and the like, and stores a service list SL. The service list SL is information that is pre-defined about services that can be achieved by combining the functions of devices that are installable in a general household. FIG. 3 illustrates a specific example of the service list SL.

As illustrated in FIG. 3, the service list SL specifies and associates, with each other, (i) the service items that are the details of the service and (ii) functions of the devices that are necessary for the service items. That is, the service list SL is a table that indicates, for each of the service items, the functions of the devices that are necessary for achieving the service item with “◯”, and the functions of the devices that are unnecessary for the service item with “_” Based on this service list SL, for example, a device with the function of “heating ventilation and air conditioning (HVAC) control” and a device with the function of “remote control” are derived to be necessary for achieving the service item “air conditioner control with remote controller”.

Such storage of the service list SL in the storage 31 beforehand is an example, and as another example, a service list SL managed with a server on the Internet may be referred to as appropriate.

Again with reference to FIG. 2, the network searcher 32, for example, searches through the home network 90 via the communication controller 36 and collects functional information from the devices 20 connected to the home network 90. Although the network searcher 32 performs a network search using DNS-based service discovery (DNS-SD) standardized by the Internet Engineering Task Force (IETF) in one example, other protocols may also be used to perform the network search.

The network searcher 32, for example, collects the functional information from the devices 20-1 through 20-5, after establishing a connection with each of the devices 20-1 through 20-5. More specifically, the network searcher 32 collects the functional information of “remote control” from the device 20-1 that is the controller, and the functional information of “HVAC control” from the device 20-2 that is an air conditioner. Similarly, the network searcher 32 collects the functional information of “air-blowing control” from the device 20-3 that is the blower, the functional information of “temperature measurement” from the device 20-4 that is the temperature sensor, and the functional information of “humidity measurement” from the device 20-5 that is the humidity sensor.

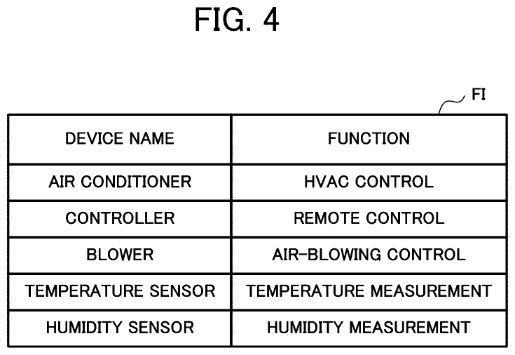

Specifically, the network searcher 32 collects functional information FI as illustrated in FIG. 4. That is, the network searcher 32 collects the functional information FI associating the devices and functions. The network searcher 32 periodically collects the functional information FI from the devices 20, to adopt to a change in functions due to update of the devices 20. The network searcher 32 may collect the functional information FI from the device 20 at the time of removal of the device 20 from the home network 90 or connection of a new device 20 to the home network 90. The collected functional information FI is then notified to the service manager 33.

Again with reference to FIG. 2, the service manager 33 creates various lists by comparing the functional information FI notified by the network searcher 32 with the service list SL stored in the storage 31. For example, the service manager 33 creates an available service list indicating available service that are available by combining the functions of the devices 20, and an unavailable service list indicating an unavailable service that is unavailable even by combining the functions of the devices 20.

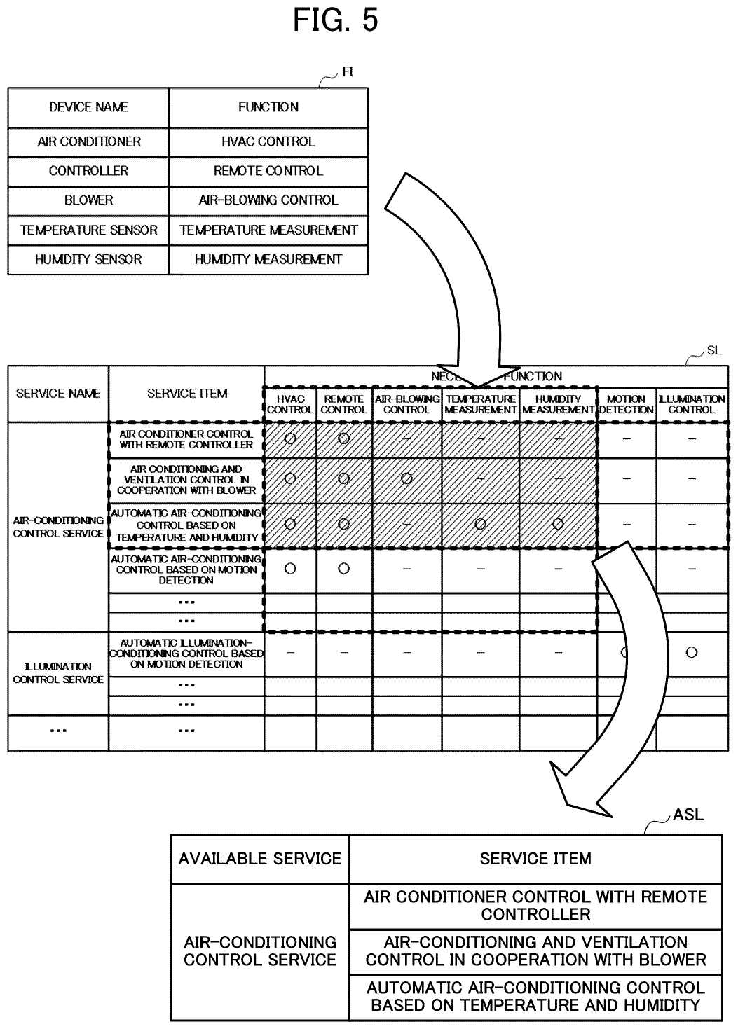

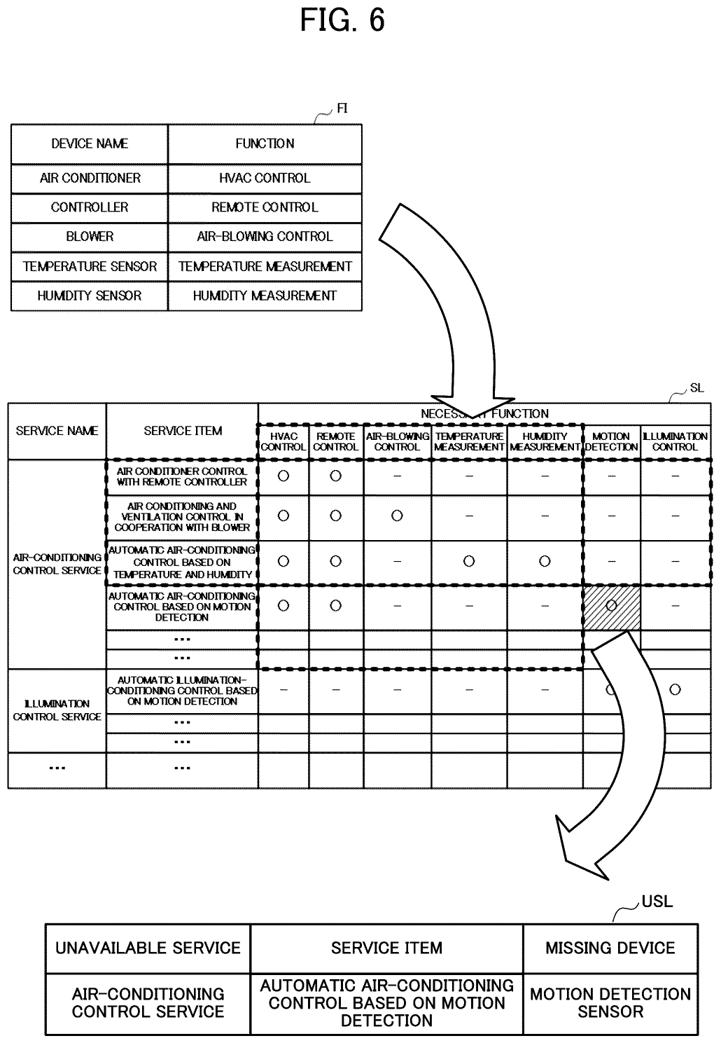

For example, as illustrated in FIG. 5, the service manager 33 identifies the service items in the service list SL that are achievable by the functions included in the functional information FI, and creates an available service list ASL. Additionally, as illustrated in FIG. 6, the service manager 33 identifies the service item in the service list SL that is unachievable by the functions included in the functional information FI, and creates an unavailable service list USL. This unavailable service list USL contains information of a missing device that is a device having a function missing to achieve the unavailable service. That is, the service manager 33 selects the missing device that is a new device having the function missing to achieve the unavailable service, and creates the unavailable service list USL containing the information of the missing device.

Although FIGS. 5 and 6 illustrate, for easy explanation, a case of targeting air-conditioning control services only, the service manager 33 is taken to create the available service list ASL and the unavailable service list USL targeting other services such as illumination control services. Additionally, the service manager 33 generates, based on the available service list ASL and the unavailable service list USL as described above, a notification screen that is described below. The display 37 that is described below displays the generated notification screen.

Again with reference to FIG. 2, when the notification screen described below is displayed on the display 37 and the user instructs the operational unit 38 to enable the service, the service setter 34 performs, on the target devices 20, settings including a setting of a control logic that is necessary. That is, to achieve the service that the user instructs to enable, for example, in addition to a data model and a communication protocol standardized by Matter, a service setting that is a setting of data elements to be collected from the target devices 20, a collection cycle in which data is collected, and the like, and a setting of a control logic for control to be performed by the target devices 20 based on the collected data, are necessary. Thus, the service setter 34 instructs the target devices 20 to establish connections, and performs, on the target devices 20, the service setting and the setting of the control logic.

In one example, information for performing the service setting and a program for setting the control logic are delivered directly to the target devices 20 from the service setter 34, that is, from the service setting device 30. Instead of direct delivery from the service setting device 30 to the target devices 20, the service setter 34 may instruct the target devices 20 to download from a server on the Internet.

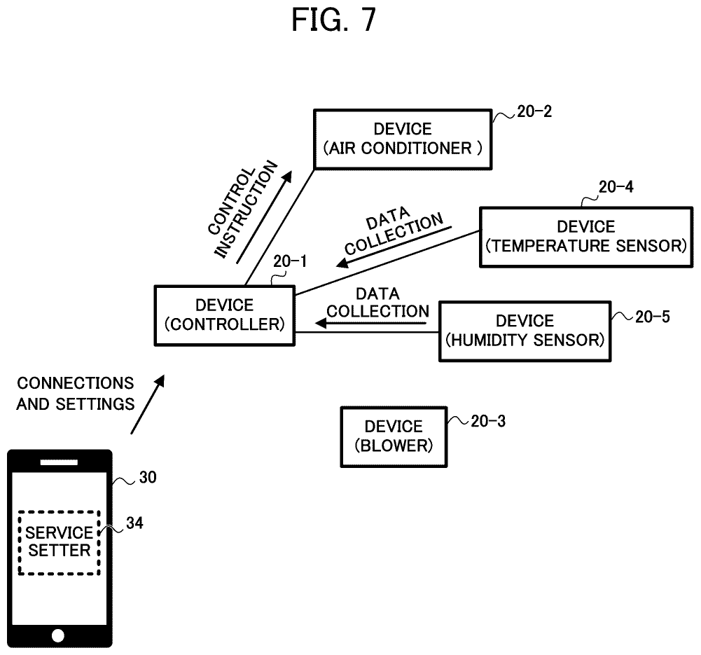

With reference to FIG. 7, a mode of performing, with the service setter 34 on the target devices 20, the service setting and the setting of the control logic is described. FIG. 7 illustrates an example of the mode of performing the service setting and the setting of the control logic on the target devices 20, in a case where an instruction is issued to enable the service item “automatic air-conditioning control based on temperature and humidity”.

As illustrated in FIG. 7, via the device 20-1 that is the controller, the service setter 34 instructs the device 20-2 that is the air conditioner, the device 20-4 that is the temperature sensor, and the device 20-5 that is the humidity sensor, to establish necessary connections. That is, to provide the service item “automatic air-conditioning control based on temperature and humidity”, establishing three connections that are a connection between the device 20-1 and the device 20-2, a connection between the device 20-1 and the device 20-4, and a connection between the device 20-1 and the device 20-5, is necessary. Thus, the service setter 34 instructs the device 20-1 to establish connections with the device 20-2, the device 20-4, and the device 20-5.

Then the service setter 34 sets, on the target devices 20, the data elements to be collected and the cycle in which data is collected. That is, as illustrated in FIG. 7, the service setter 34 performs, on the device 20-2 that is the air conditioner, a setting for collecting from the device 20-4 that is the temperature sensor and the device 20-5 that is the humidity sensor, for example, indoor temperature information and indoor humidity information at one-minute intervals. Additionally, the service setter 34 sets the control logic on the target devices 20. That is, as illustrated in FIG. 7, the service setter 34 sets, on the device 20-2 that is the air conditioner, a control logic for performing, based on the collected temperature information and humidity information, on-off switching of an air-conditioning operation, a change in a temperature setting, and the like. The control logic may be set by enabling a function that is pre-installed in the devices 20, or by installing a control logic program into the target devices 20 from the service setting device 30 or a server on the Internet.

Again with reference to FIG. 2, the application unit 35 generates data of communication between the devices 20, for example, in accordance with a defined protocol.

The communication controller 36 is, for example, a communication unit, and sends and receives a packet for communication.

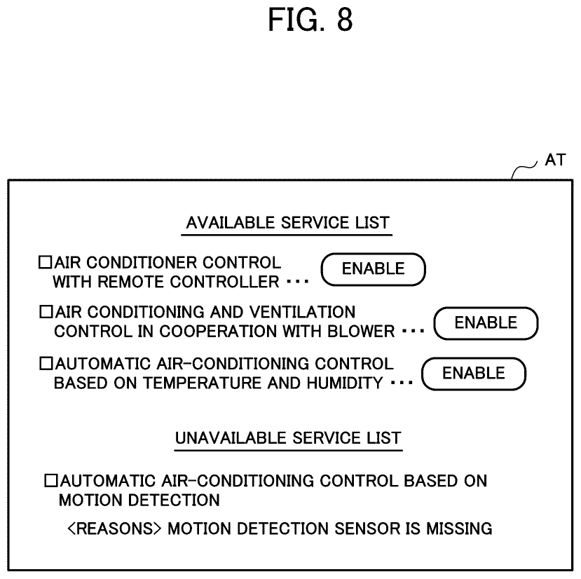

The display 37 is a display unit such as a liquid crystal display (LCD) or an organic electro luminescence (EL) display, and displays various screens for notification to the user. For example, the display 37 displays a notification screen AT as illustrated in FIG. 8 that is generated by the service manager 33 based on the available service list ASL and the unavailable service list USL as described above. This notification screen AT contains a list of available services and a list of unavailable services. The list of available services contains buttons for instructing activation. The list of unavailable services contains information of a missing device that is missing.

Again with reference to FIG. 2, the operational unit 38 is, for example, a touch panel, and receives an operation from the user on the screen displayed on the display 37. For example, when the display 37 displays the notification screen AT as illustrated in FIG. 8, in response to the user touching the button for instructing activation, activation of a service corresponding to this button is accepted.

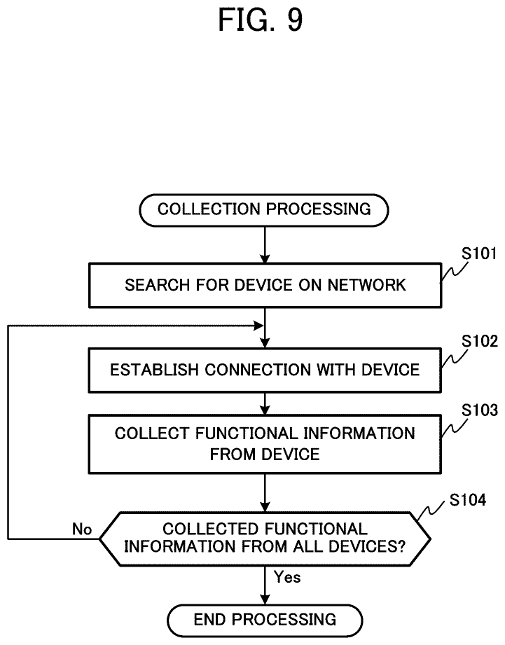

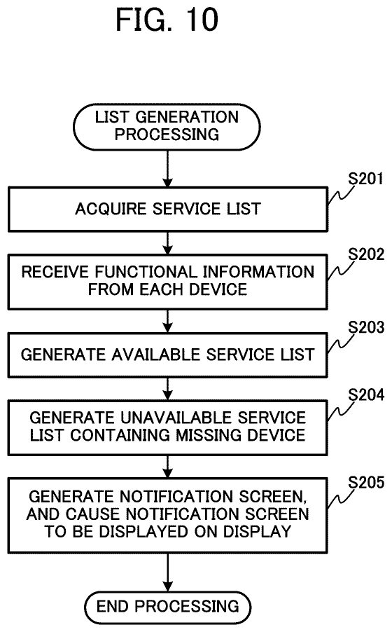

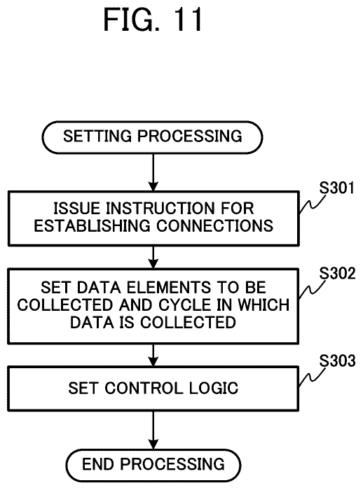

Hereinafter, an operation of the service setting device 30 having the aforementioned configuration is described with reference to FIGS. 9-11. FIG. 9 is a flowchart describing an example of collection processing according to Embodiment 1 of the present disclosure. FIG. 10 is a flowchart describing an example of list generation processing according to Embodiment 1 of the present disclosure. FIG. 11 is a flowchart describing an example of setting processing according to Embodiment 1 of the present disclosure.

First, the collection processing is described below with reference to FIG. 9. This collection processing is executed, for example, repeatedly at regular intervals by the network searcher 32.

Firstly, the network searcher 32 searches for the devices 20 on the home network 90 (step S101). For example, the network searcher 32 performs a network search using DNS-SD standardized by the IETF. The network searcher 32 may perform a network search using other type of protocol.

The network searcher 32 establishes a connection with the device 20 (step S102). The network searcher 32 establishes a connection with one of the devices 20-1 through 20-5 at every time step S102 is repeated, to establish a connection with the devices 20-1 through 20-5 in turn.

The network searcher 32 collects the functional information from the device 20 (step S103). That is, the network searcher 32 collects, from the device 20 with which a connection has been established in step S102 above, the functional information that is information about the function of this device 20. Step S103 is an example of a collection step.

The network searcher 32 determines whether the functional information is collected from all of the devices 20 (step S104).

Upon determining that collection of the functional information from all of the devices 20 is not completed, (NO in step S104), the network searcher 32 returns the processing to step S102 above.

Conversely, upon determining that the functional information is collected from all of the devices 20 (YES in step S104), the network searcher 32 ends the collection processing.

Through the collection processing as described above, the network searcher 32 collects, for example, the functional information FI as illustrated in FIG. 4 mentioned above.

Next, the list generation processing is described with reference to FIG. 10. The list generation processing is executed by the service manager 33 after the collection processing of FIG. 9 mentioned above is completed.

Firstly, the service manager 33 acquires the service list SL (step S201). For example, the service manager 33 acquires the service list SL stored in the storage 31. The service manager 33 may acquire the service list SL managed by a server on the Internet from the server.

The service manager 33 receives the functional information of each of the devices 20 (step S202). For example, the service manager 33 receives the functional information FI as illustrated in FIG. 4 mentioned above that is transmitted from the network searcher 32.

The service manager 33 generates the available service list (step S203). For example, as illustrated in FIG. 5 mentioned above, the service manager 33 identifies the service items in the service list SL that are achievable by the functions included in the functional information FI, and creates the available service list ASL.

The service manager 33 generates the unavailable service list containing the missing device (step S204). For example, as illustrated in FIG. 6 mentioned above, the service manager 33 identifies the service item in the service list SL that is unachievable by the functions included in the functional information FI, and creates the unavailable service list USL. This unavailable service list USL contains the missing device that is a device having a function missing to achieve the unavailable service. That is, the service manager 33 selects the missing device that is a new device having the function missing to achieve the unavailable service, and creates the unavailable service list USL containing the missing device. Step S204 is an example of an identification step.

The service manager 33 generates the notification screen and causes this notification screen to be displayed on the display 37 (step S205). For example, the service manager 33 causes the display 37 to display the notification screen AT of FIG. 8 that is generated based on the available service list ASL and the unavailable service list USL. Step S205 is an example display step.

Next, the setting processing is described with reference to FIG. 11. This setting processing is executed by the service setter 34 when the notification screen AT as illustrated in FIG. 8 is displayed on the display 37, in response to the user issuing an instruction for enabling a service of the services.

Firstly, the service setter 34 issues an instruction for establishing connections (step S301). That is, to achieve the service that the user instructs to enable, the service setter 34 instructs the target devices 20 to establish connections. For example, in the case where an instruction for enabling the service item “automatic air-conditioning control based on temperature and humidity” is issued, as illustrated in FIG. 7 mentioned above, the service setter 34 instructs the device 20-1 that is the controller to establish connections with the device 20-2 that is the air conditioner, the device 20-4 that is the temperature sensor, and the device 20-5 that is the humidity sensor.

The service setter 34 sets the data elements to be collected and the cycle in which data is collected (step S302). For example, in the case where an instruction for enabling the service item “automatic air-conditioning control based on temperature and humidity” is issued, the service setter 34 performs, on the device 20-2 that is the air conditioner, settings for collecting, from the device 20-4 that is the temperature sensor and the device 20-5 that is the humidity sensor, indoor temperature information and indoor humidity information at one-minute intervals, as illustrated in FIG. 7.

The service setter 34 sets the control logic (step S303). For example, in the case where the instruction for enabling the service item “automatic air-conditioning control based on temperature and humidity” is issued, the service setter 34 performs, on the device 20-2 that is the air conditioner, a control logic for performing, based on the collected temperature information and humidity information, on-off switching of an air-conditioning operation, a change in a temperature setting, and the like, as illustrated in FIG. 7. The control logic may be set by enabling a function that is pre-installed in the device 20, or by installing a control logic program from the service setting device 30 or a server on the Internet.

The collection processing and the list generation processing as described above enable presenting to the user the available services that are available by combining the functions of the devices 20 connected to the home network 90. Furthermore, presenting the missing device that is a device missing for achievement of the unavailable service enables prompting the user to purchase the missing device. Furthermore, according to the setting processing as described above, since necessary settings are performed simply with an instruction from the user to enable the service, the service that the user instructs to enable can be provided to the user without asking a professional worker to work.

As a result, available services can be presented to the user.

Embodiment 2 Although Embodiment 1 above describes a case where no duplication of functions exists in the functional information collected from the devices 20 on the home network 90 and each of the devices 20 has only one function, in real cases, duplication of functions may exist, that is, multiple devices 20 may have the same function, or a single device 20 may have multiple functions. In these cases, providing connection instructions to the devices 20 and performing settings on the devices 20 are expected to be difficult. Thus, a service setting device 30 according to Embodiment 2 is described below that can handle, for the devices 20 on the home network 90, the case where the devices 20 include devices having the same function and the case where the devices 20 include a device 20 having multiple functions.

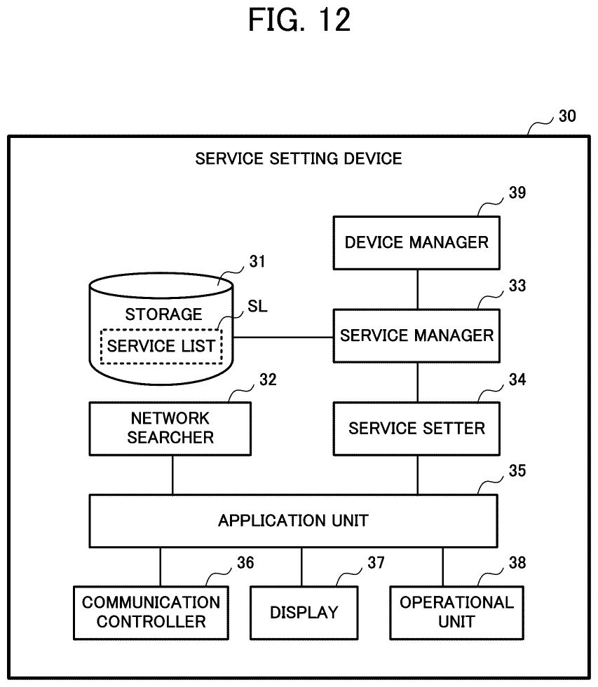

FIG. 12 is a block diagram illustrating an example of configuration of the service setting device 30 according to Embodiment 2 of the present disclosure.

As illustrated in FIG. 12, the service setting device 30 includes a device manager 39, the storage 31, the network searcher 32 that is an example of collection means, the service manager 33 that is an example of identification means, the service setter 34 that is an example of setting means, the application unit 35, the communication controller 36, the display 37 that is an example of display means, and the operational unit 38. That is, the service setting device 30 illustrated in FIG. 12 has configuration obtained by adding the device manager 39 to the configuration of the service setting device 30 of FIG. 2 above. The device manager 39, the network searcher 32, the service manager 33, the service setter 34, and the application unit 35 are achieved by, for example, a CPU using a RAM as a work memory to appropriately execute a program stored in a ROM.

The device manager 39 manages the devices 20 on the home network 90 and issues, to the service manager 33, an instruction on the devices 20 with which connections are to be established.

For example, the device manager 39 refers to the functional information collected by the network searcher 32 and determines whether functions that are the same exist and whether a device 20 having multiple functions exists. When determining that functions that are the same exist or when determining that the device 20 having multiple functions exists, a selection screen described below is generated and is displayed on the display 37.

Hereinafter, a case is described where the device 20-2 that is the air conditioner has a function of “HVAC control” and a function of “temperature measurement”.

The network searcher 32, for example, collects the functional information from the devices 20-1 through 20-5, after establishing a connection with each of the devices 20-1 through 20-5. More specifically, the network searcher 32 collects the functional information of “remote control” from the device 20-1 that is the controller, and the functional information of “HVAC control” and the functional information “temperature measurement” from the device 20-2 that is the air conditioner. Similarly, the network searcher 32 collects the functional information of “air-blowing control” from the device 20-3 that is the blower, the functional information of “temperature measurement” from the device 20-4 that is the temperature sensor, and the functional information of “humidity measurement” from the device 20-5 that is the humidity sensor.

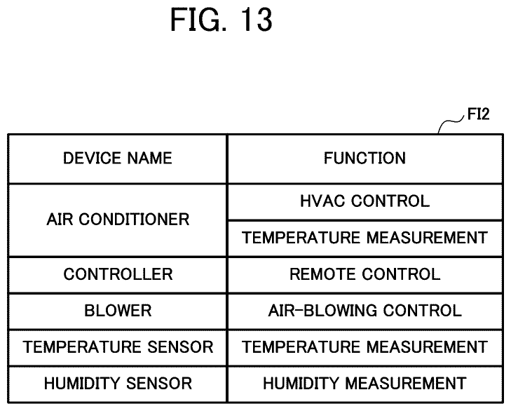

Specifically, the network searcher 32 collects the functional information FI2 as illustrated in FIG. 13. That is, the network searcher 32 collects the functional information FI2 associating the devices and functions. The functional information FI2 indicates that only the air conditioner has two functions, “HVAC control” and “temperature measurement”. The network searcher 32 periodically collects the functional information FI2 from the devices 20, to adopt to a change in functions due to update of the devices 20. The network searcher 32 may collect the functional information FI2 from the devices 20 at the time of removal of a device 20 from the home network 90 or connection of a new device 20 to the home network 90. The collected functional information FI2 is then notified to the device manager 39.

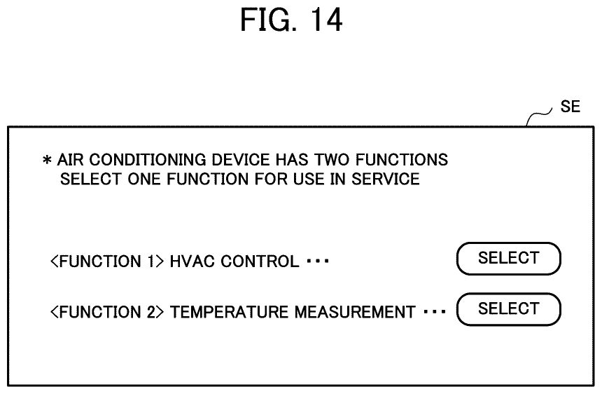

Again with reference to FIG. 12, the device manager 39 refers to the functional information FI2 collected by the network searcher 32 and determines whether functions that are the same exist and whether the device 20 having multiple functions exists. In the case of the functional information FI2 as illustrated in FIG. 13, the device manager 39 determines that the device 20 having multiple functions exists, and thus generates a selection screen SE as illustrated in FIG. 14 and causes the selection screen SE to be displayed on the display 37. This selection screen SE allows the user to select any of the functions “HVAC control” and “temperature measurement” that the air conditioner has. When any of the functions is selected by the user with the selection screen SE displayed on the display 37, the device manager 39 notifies the service manager 33 of the functional information FI2 modified in accordance with this selection.

Hereinafter, a case is described where the user selects the function “HVAC control” on the selection screen SE.

Again with reference to FIG. 12, the service manager 33 creates an available service list ALS2 and the unavailable service list USL by comparing the functional information FI2 notified by the device manager 39, that is, the functional information FI2 modified in accordance with the selection, with the service list SL stored in the storage 31.

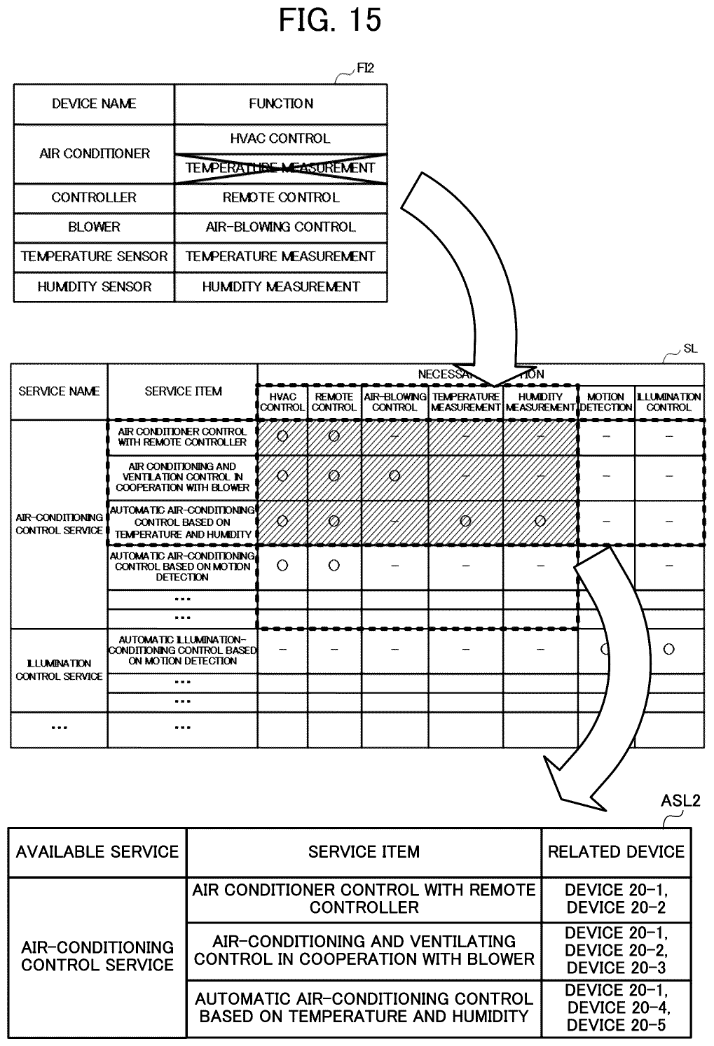

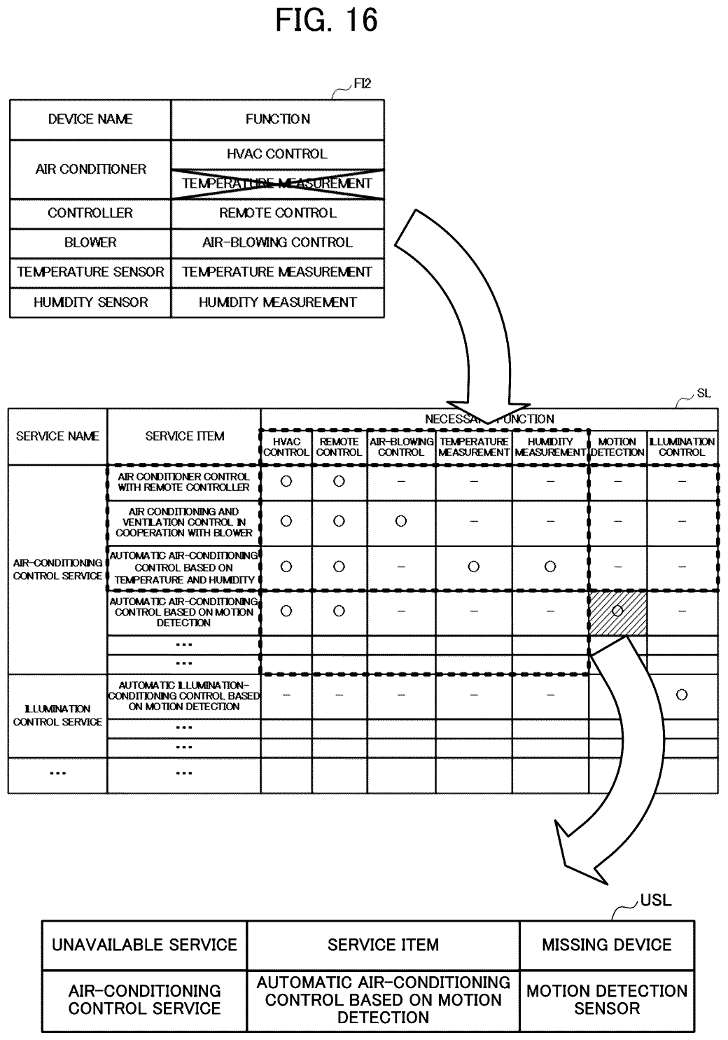

For example, as illustrated in FIG. 15, the service manager 33 identifies the service items in the service list SL that are achievable by the functions included in the modified functional information FI2, and creates the available service list ASL2. This available service list ASL2 contains information of related devices that are devices corresponding to services. Additionally, as illustrated in FIG. 16, the service manager 33 identifies the service item in the service list SL that is unachievable by the functions included in the modified functional information FI2, and creates the unavailable service list USL.

Although FIGS. 15 and 16 illustrate, for easy explanation, a case of targeting an air-conditioning control service only, the service manager 33 is taken to create the available service list ASL2 and the unavailable service list USL targeting other services such as an illumination control service. Additionally, the service manager 33 generates, based on the available service list ASL2 and the unavailable service list USL as described above, the notification screen AT as illustrated in FIG. 8 mentioned above. The display 37 displays the generated notification screen AT.

Similarly to Embodiment 1, when the display 37 displays the notification screen, in response to the user issuing an instruction for enabling any service, the service setter 34 performs, on the target devices 20, settings including a setting of a control logic that is necessary.

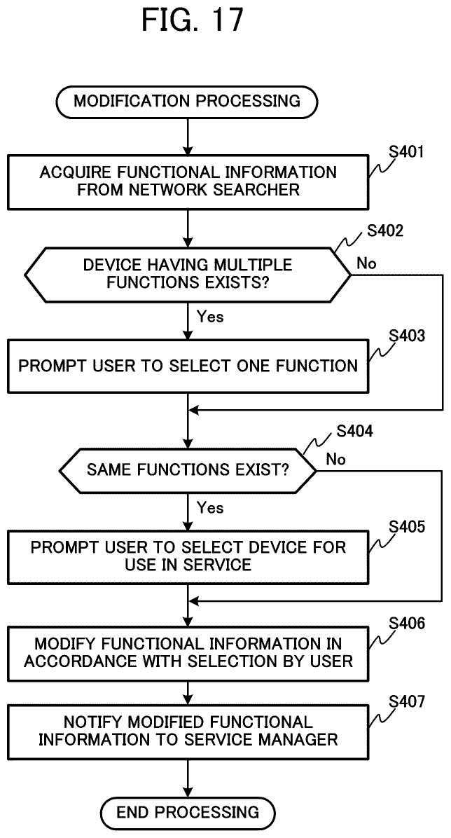

Hereinafter, an operation of the service setting device 30 according to Embodiment 2 is described with reference to FIG. 17. FIG. 17 is a flowchart describing an example of modification processing according to Embodiment 2 of the present disclosure.

Firstly, the device manager 39 acquires the functional information from the network searcher 32 (step S401). For example, the device manager 39 acquires the functional information FI2 as illustrated in FIG. 13 that is collected by the network searcher 32.

The device manager 39 determines whether the device 20 having multiple functions exists (step S402). For example, the device manager 39 refers to the functional information FI2 of FIG. 13 and determines whether the device 20 having multiple functions exists.

Upon determining that none of the devices 20 have multiple functions (NO in step S402), the device manager 39 advances the processing to step S404 described below.

Conversely, upon determining that the device 20 having multiple functions exists (YES in step S402), the device manager 39 prompts the user to select any of the functions (step S403). For example, the device manager 39 generates the selection screen SE as illustrated in FIG. 14 mentioned above and causes the selection screen SE to be displayed on the display 37, to allow the user to select any of the functions.

The device manager 39 determines whether functions that are the same exist (step S404). That is, the device manager 39 refers to the functional information FI2 of FIG. 13 and determines whether duplication of functions exists.

Upon determining that functions that are the same do not exist (NO in step S404), the device manager 39 advances the processing to step S406 described below.

Conversely, upon determining that functions that are the same exist (YES in step S404), the device manager 39 prompts the user to select a device 20 for use in the service (step S405). That is, the device manager 39 generates a selection screen listing the devices 20 having the same function for allowing selection of one device 20 of the listed devices 20, and causes the selection screen to be displayed on the display 37, to allow the user to select any of the devices 20.

The device manager 39 modifies the functional information in accordance with the selection by the user (step S406). For example, in the case where the function “HVAC control” is selected when the display 37 displays the selection screen SE of FIG. 14, the device manager 39 modifies the functional information FI2 such that the unselected function “temperature measurement” becomes invalid, as illustrated in FIGS. 15 and 16.

The device manager 39 notifies the modified functional information FI2 to the service manager 33 (step S407).

Through the modification processing as described above, even in the case where functions that are the same exist or the case where a single device 20 has multiple functions, the functional information FI2 having undergo modification is notified to the service manager 33. Thus, the service manager 33 can generate the available service list ASL2 as illustrated in FIG. 15 mentioned above and can also generate the unavailable service list USL as illustrated in FIG. 16 mentioned above. This configuration enables, similarly to Embodiment 1, presenting to the user the available services that are available by combining the functions of the devices 20 connected to the home network 90. Furthermore, presenting the missing device that is a device missing for achievement of the unavailable service enables prompting the user to purchase the missing device. Furthermore, similarly to Embodiment 1 described above, since necessary settings are performed simply with an instruction from the user to enable the service, the service that the user instructs to enable can be provided to the user without asking a professional worker to work.

As a result, available services can be presented to the user.

Other Embodiments Although Embodiment 2 describes a case of causing the selection screen SE as illustrated in FIG. 14 to be displayed on the display 37 and prompting the user to make selection on the device 20, this selection on the device 20 may be automatically performed with the device manager 39. For example, the device manager 39 may select, in view of energy saving, a device 20 that enables a lower total power consumption.

Although Embodiments 1 and 2 above describe an example of using the home control system 1 for controlling the devices 20 installed in the house H, the present disclosure can also be used for a home control system for controlling a device within a facility such as an office building and a factory.

In the above embodiments, the program executable by the service setting device 30 may be distributed by storage in a computer-readable recording medium, such as a compact disc read only memory (CD-ROM), a digital versatile disc (DVD), a magneto-optical (MO) disk, a universal serial bus (USB) memory, or a memory card. Furthermore, installing such program in a special-purpose computer or a general-purpose computer can cause the computer to function as the service setting device 30 according to Embodiments 1 and 2 described above.

The above program may be stored in a disk device included in a server on a communication network, such as the Internet, and may be, for example, superimposed on a carrier wave to be downloaded to a computer. The processing described above may also be executed by the program activated and executed while being transferred through a communication network. The processing described above may also be executed by entirely or partially executing the program on a server while a computer is transmitting and receiving information relating to the processing through a communication network.

When the above-described functions are, for example, achieved partly by an operating system (OS) and an application program or in cooperation with the OS and the application program, the program other than the OS may be stored on the above recording medium for distribution or may be downloaded to the computer.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitably usable in a service setting device, a home control system, a service management method, and a program that enable presenting an available service to a user.

### REFERENCE SIGNS LIST

1 Home control system
10 Access point
20 (20-1 through 20-5) Device
30 Service setting device
31 Storage
32 Network searcher
33 Service manager
34 Service setter
35 Application unit
36 Communication controller
37 Display
38 Operational unit
39 Device manager
90 Home network

1. A service setting device, comprising:
processing circuitry to
collect functional information indicating functions of devices connected to a home network,
modify the functional information when the collected functional information indicates that at least one device of the devices has a plurality of functions,
identify, based on the modified functional information and a list associating services and functions necessary for the services, an available service that is available by combining the functions of the devices, and
cause the identified available service to be displayed.

2. The service setting device according to claim 1, wherein
the processing circuitry
modifies the functional information so as to retain, among the plurality of functions that each of the at least one device has, only a function selected by a user,
identifies an unavailable service that is unavailable even by combining the functions of the devices connected to the home network, and selects a missing device having a function missing to achieve the identified unavailable service, and
causes the selected missing device to be displayed.

3. The service setting device according to claim 1, wherein
the processing circuitry performs, on target devices among the devices connected to the home network, settings including a setting of a control logic that is necessary, to achieve the identified available service.

4. The service setting device according to claim 3, wherein
the processing circuitry causes a connection between the target devices among the devices connected to the home network to be established so as to allow the plurality of target devices to cooperate, and thereby provides the available service.

5. A home control system in which devices and a service setting device are connected to a home network, wherein
the service setting device includes processing circuitry to
collect functional information indicating functions of the devices,
modify the functional information when the collected functional information indicates that at least one device of the devices has a plurality of functions,
identify, based on the modified functional information and a list associating services and functions necessary for the services, an available service that is available by combining the functions of the devices, and
cause the identified available service to be displayed.

6. A service management method, comprising:
collecting functional information indicating functions of devices connected to a home network;
modifying the functional information when the collected functional information indicates that at least one device of the devices has a plurality of functions,
identifying, based on the modified functional information and a list associating services and functions necessary for the services, an available service that is available by combining the functions of the devices; and
causing the identified available service to be displayed on a display.

7. (canceled)
